(19) United States
(12) Patent Application Publication
(10) Pub. No.: US 2008/0026245 A1
(43) Pub. Date: Jan. 31, 2008

(54) Vibration damping material, structural laminates, and processes for making same

(76) Inventor: Yuji Saga, Tochigi (JP)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/803,480

(22) Filed: May 15, 2007

Related U.S. Application Data
(60) Provisional application No. 60/833,055, filed on Jul. 25, 2006.

(51) Int. Cl. B32B 15/088; B29C 41/00; C04B 28/36

(52) U.S. Cl. 428/626; 106/287.23; 264/239

(57) ABSTRACT

Viscoelastic resin compositions are provided, comprising aliphatic polyamide, polyamide 6T6I, and select plasticizers, all in advantageous weight percentages. Structural laminates including such compositions are also disclosed.

### CROSS REFERENCE TO RELATED APPLICATIONS

This application claims the benefit of priority to U.S. Provisional Application No. 60/833,055, filed Jul. 25, 2006.

### FIELD OF THE INVENTION

The present invention relates to a viscoelastic resin composition for use as a vibration damping material and a vibration damping structure using the same.

### BACKGROUND OF THE INVENTION

Noises and vibration problems have become an object of public concern as an environmental pollution with development of means of transportation and increase in residential areas which are located near factories and the like. Further, in workshops, there is a requirement to limit noises and vibration to improve the working atmosphere. To cope with these requirements, metallic materials and structures that are a source of noises and vibration can be bonded to polymer in order to absorb vibrational energy.

Composite laminate structures have been proposed wherein a middle layer having viscoelasticity is sandwiched by metal layers. This type of a composite vibration damping material has been studied and employed as oil pans of automobiles, engine covers, chutes of hoppers, stopper of conveying apparatus, domestic electric equipments, vibration reducing members of other metal processing machines, structural members of precision machines in which prevention of vibration is desirable and the like.

In general the vibration damping property of such a composite vibration damping material depends upon the properties of a viscoelastic layer which constitutes the middle layer thereof. When the vibration damping property is expressed as a loss factor (which is a measure of conversion of an external vibrational energy into a heat energy by internal friction, and is corresponding to a value relating to mechanical hysteresis loss due to vibration), the property shows a peak at a certain temperature. It has been known that it is most effective to use a vibration damping material at about this temperature showing the peak property.

A composite vibration damping material should therefore have a high value of the above loss factor as well as a high adhesive strength between a viscoelastic middle layer and a metal layer. The composite vibration damping materials made of known viscoelastic compositions have problems in meeting all of the requirements of an ideal material and are unsatisfactory in one way or another. In addition to the above requisite properties, it is necessary that a composite vibration damping material should stand processing such as press, bending and the like. A composite vibration damping material made of the conventional viscoelastic compositions is liable to produce wrinkle, crack and the like, and is also unsatisfactory.

Hitherto, the following examples of a resin layer of the sandwich-type vibration damping material have been known: a simple polyester resin (Japanese Laid-Open Patent Publication No. 50-143880); a resin composition obtained by adding a plasticizer to a polyester (Japanese Laid-Open Patent Publication No. 51-93770); a resin composition obtained by mixing an organic peroxide with a polyester (Japanese Laid-Open Patent Publication Nos. 51-41080 and 51-83640); a resin composition which is a combination of a plurality of polyesters (Japanese Laid-Open Patent Publication Nos. 62-295949 and 63-202446); a simple polyurethane foam (Japanese Laid-Open Patent Publication No. 51-91981), a simple polyamide resin (Japanese Laid-Open Patent Publication No. 56-159160); a simple ethylene-polyvinyl acetate copolymer (Japanese Laid-Open Patent Publication No. 57-34949); a resin composition obtained by adding a plasticizer and a tackifier to a polyvinyl butyral or to a combination of a polyvinyl butyral and a polyvinyl acetate (Japanese Patent Publication No. 55-27975); a copolymer of a isocyanate prepolymer and a vinyl monomer (Japanese Patent Publication No. 52-26554); copolymers disclosed in Japanese Laid-Open Patent Publication No. 60-258262, Japanese Patent Publication Nos. 39-12451 and 45-34703, and U.S. Pat. No. 4,447,493; and the like.

Polyamide resin material is lighter than metal and has excellent dampening property, rigidity, heat resistance, oil resistance, etc. It is used as various types of molding material, for example, for automobile parts in order reduce weight and noise.

For example, Japanese Kokai Patent Application No. Hei 2[1990]-120360 discloses a polyamide composition, which contains nylon 6 resin, nylon 66 resin, and an aromatic amorphous nylon in prescribed amounts as essential components, and can be used to manufacture molding products used for mechanical parts with improved dampening characteristics and mechanical characteristics, especially, at 100-120° C.

Also, Japanese Kokai Patent Application No. Hei 3[1991]-143956 discloses a dampening resin molding product, which is made of a nylon mixture consisting a crystalline nylon resin and an amorphous nylon resin and is mechanically installed on an engine or other peripheral machines.

Japanese Kokai Patent Application No. Hei 4[1992]-89863 (patent reference 3) discloses a sound-blocking resin composition composed of a polyamide resin, such as nylon 6 or nylon 66, a plasticizer, and a reinforcing fiber.

Japanese Kokai Patent Application No. Hei 11 [1999]-49950 (patent reference 4) discloses a resin material substitutable for the fixture of engine parts, which contains (A) aliphatic polyamide, (B) a half-aromatic polyamide having repeated units comprised of a part derived from aromatic carboxylic acid and a part derived from aliphatic diamine. The aforementioned resin material has good rigidity at high temperatures and is characterized by the fact that that the vibration characteristic will not deteriorate significantly due to temperature variation.

Vibration damping resins displaying viscoelastic behavior for use in forming metal laminates are known. For example, U.S. Pat. No. 4,859,523, the teachings of which are incorporated herein by reference, describes polyurethanes useful for forming metal-resin-metal composites. The viscoelastic resin layer, that adheres two metal layers, damps vibration by converting external vibrational energy to heat energy. Vibration damping is useful in reduction of noise and prevention of metal fatigue. Vibration-damped metal has a wide variety of applications where vibrational noise is of concern, particularly in the automotive industry. The use of vibration damping composites is known for oil pans, engine covers, rocker panels, air filters covers, and other automotive parts.

It can be appreciated that a viscoelastic resin must have chemical and physical stability over a wide temperature range. It must also be able to both adhere the layers of metal together and effectively damp vibration over a wide temperature range. Throughout the entire processing temperature range of the laminate-forming process, component-forming process, and baking process, the resin must not ooze from between the metal layers. The resin should provide sufficient peel strength upon formation of the composite so as to survive passage through the coil coating/laminating process or any other conditions selected to form the composite. To withstand the drawing and/or stamping steps which occurs during component formation, high lap shear strength is required.

One of the specific goals for a resin in accordance with this invention is to obtain, over a broad operating temperature range, a composite loss factor or tan(δ) of at least about 0.05 and preferably of at least about 0.1. Loss factor is a measure of conversion of external vibrational energy into heat energy by internal friction in the resin layer. The higher the loss factor, the greater the amount of vibrational energy that is converted to heat. This value may be measured on an Oberst-Beam by ASTM procedure E756-83. The goal of obtaining a high loss factor over a broad temperature range is desirably tied in to the ability of the resin to be used on a coil-line which has radical processing conditions involving mechanical stresses during the fabrication process and time/temperature parameters which can engender reaction kinetics completely unknown to anyone. A minimum shear strength of about 1000 psi at room temperature (e.g., 25° C.) is sought. Additionally, decrease in lap shear must be minimal at elevated temperatures; the lap shear should be about 750 psi at 250° F. (126° C.). A minimum peel strength of at least about 8, and preferably at least about 12 lbs/inch is sought for room temperature values. Furthermore, there should be no loss in damping or mechanical properties after a one-hour bake at 400° F. (206° C.). when tested at room temperature.

In other literature that describes examples of resins for vibration absorption, U.S. Pat. No. 4,859,523 describes a viscoelastic resin which comprises a reaction product of a polyester diol having a molecular weight of 400 to 6,000, wherein at least 60 mol % of the polyester diol is a dicarboxylic acid component which is an aromatic dicarboxylic acid and at least 30 mol % of the polyester diol is a glycol component which is neopentyl glycol or its derivative, an aliphatic polyester diol having a molecular weight of 600 to 6,000, a diisocyanate compound; and a chain extender

Metal-plastic-metal laminates have been described in various U.S. and foreign patents. Exemplary patents include U.S. Pat. No. 3,582,427, U.S. Pat. No. 4,229,504, U.S. Pat. No. 4,204,022, U.S. Pat. No. 4,313,996, U.S. Pat. No. 4,369,222 and EPA 19,835. These laminates are useful as light weight replacements for sheet steel in cars and trucks. Relatively thin laminates are useful in flexible packaging end use applications while relatively thick laminates are useful as construction laminates.

Methods of preparing such laminates are also known. One method includes bringing at least one layer of plastic and at least one layer of metal into intimate contact and subjecting them to suitable heat and pressure, using, for example, a platen press. A more efficient and continuous method involves the well known extrusion processes—extrusion coating or extrusion lamination. Often an intermediate layer of adhesive or primer, in the form of a film or coating, is used in conjunction with these methods in insure adequate adhesion between the metal substrate and the plastic.

In the past, one primary incentive for considering the replacement of sheet steel with metal-polymer laminates was the weight saving that could be obtained with equivalent stiffness. Placing thin steel skins on the outside of the laminate optimal use of high yield, high modulus steel and allows the structurally ineffective (in bending) middle portion of the composite to be light weight plastic, resulting in the primary advantage of steel-plastic laminates—weight reduction versus an equivalent stiffness sheet steel, but at substantially less cost penalty compared to other weight-reducing materials such as aluminum sheet. In other cases it has been desired to obtain sound or vibration damping from the laminate. In the past, in order to obtain such vibration damping, manufacturers would provide a laminate having relatively thick skins (400-500 μm) and a relatively thin, low modulus viscoelastic polymer core (200-300 μm). However, in order to obtain equivalent stiffness to the steel it replaced, it was necessary to increase the overall thickness of the steel in the sound damping laminate. This resulted in a much heavier laminate than the equivalent stiffness steel it replaced. What is needed are laminates that provide both light weight and sound damping.

In other examples of vibration absorbing laminates, U.S. Pat. No. 4,599,261 describes a metal-polymer-metal structural laminate comprising a core of polymeric resinous material having adhered to each side thereof a metal skin layer.

U.S. Pat. No. 5,356,715 describes a viscoelastic, vibration-damping resin consisting essentially of the reaction product between bisphenol-derived epoxy resins having terminal epoxy functionalities and providing a composite loss factor of at least about 0.05 over a temperature range of at least about 55.5° C. The '715 patent also describes a vibration-damping composite comprising a pair of metal sheets adhered together by a viscoelastic vibration-damping resin consisting essentially of the abovementioned vibration-dampling resin.

U.S. Pat. No. 5,411,810 describes a viscoelastic resin composition for a vibration damping material. The resin comprises a low Tg polyester resin and a high Tg resin which is at least one selected from the group consisting of amorphous polyester resins, phenoxy resins, and epoxy resins.

U.S. Pat. No. 6,726,957 describes a cured, thermal insulating, corrosion resisting and noise reducing coating composition comprising an epoxy resin, a mixed methyl-phenyl functional silicone polymer, a catalyst ranging from about 1-7% of the total weight of the composition, a silane ranging from about 1-3% of the total weight of the composition, an anti-corrosive pigment ranging from about 5-15% of the total weight of the composition, an inert film reinforcing pigment ranging from about 6-10% of the total weight of the composition, a plurality of calcium silicate fibers ranging from about 4-8% of the total weight of the composition, a mixture of synthetic silicone rubber, silica and fillers ranging from about 10-20% of the total weight of the composition, and an organic solvent ranging from about 5-50% of the total weight of the composition.

U.S. Pat. No. 5,227,234 describes a vibration damping sheet which comprises a sheet substrate comprising an asphaltic material and a crystalline polyolefin particles on a surface of said sheet substrate.

One object of the present invention is to provide a viscoelastic composition useful as a vibration damping material or for a middle layer of a composite vibration damping material. That is, the present invention provides a viscoelastic resin useful for a vibration damping material which shows improved vibration damping property as well as improved adhesion when it is sandwiched between steel plates and improved press moldability when it is used as a middle layer of a composite vibration damping steel plate.

Another object of the present invention is to provide a composite vibration damping steel plate obtained by using the viscoelastic resin of the present invention.

### SUMMARY OF THE INVENTION

The term PA6T6I in the present disclosure refers to polyamides made by polymerizing hexamethylenediamine with terephthalic acid and/or its derivatives acid and isophthalic acid and/or its derivatives.

In one embodiment the present invention is composition that comprises; an aliphatic polylamide in an amount of 20-95 weight % of total formulation (wt %), and preferably 30-90 wt %. The composition also comprise 1-40 wt % of polyamide PA6T6I, preferably 2-20 wt %, and 0.5-20 wt % of a plasticizer, preferably 1-10 wt %.

The aliphatic polyamide that the invention comprises is miscible with PA6T6I and the plasticizer is selected from the group consisting of caprolactam, oligoamide, sulfone amide and benzoate.

The invention is further directed to a metal-polymer-metal structural laminate that comprises a core of polymeric material having adhered to each side thereof a metal skin layer wherein:

(a) said metal skin layer is about 0.1 to about 10 mm thick;
(b) said laminate has a ratio of core thickness to skin thickness of between about 1:3 and about 20:1;
(c) said laminate total thickness is between about 0.3 mm and about 10 mm;
(d) said polymeric material comprises an aliphatic polylamide in an amount of 20-95 weight % of total formulation (wt %). The composition also comprise 1-40 wt % of polyamide PA6T6I, and 0.5-20 wt % of a plasticizer.

The aliphatic polyamide that the invention comprises is miscible with PA6T6I and the plasticizer is selected from the group consisting of caprolactam, oligoamide, sulfone amide and benzoate.

The structural laminate of the invention may also comprise metal skin layers on each side of the core that are of different thicknesses.

The structural laminate of the invention may also comprise metal skin layers on each side of the core that comprise different metals.

The ratio of core thickness to skin thickness of the structural laminate of the invention may also be between 1:2 and 3:1.

The total laminate thickness of the structural laminate of the invention may also be between 0.6 mm and 1.5 mm.

In a further embodiment of the invention the core comprises a solid filler and in a still further embodiment of the invention the metal skin is steel. In a still further embodiment of the invention the metal skin is aluminum.

The present invention is also directed to a method for manufacturing a sound or vibration dampening molding product characterized by having
(i) a step of mixing (1) aliphatic polyamide, (2) amorphous polyamide, and (3) plasticizer,
(ii) a step of molding the molding product using the composition obtained in step (a) (1).

In a further embodiment of the invention the method for manufacturing said dampening molding product is characterized by having
(A) a step, in which (2) amorphous polyamide is added into (1) aliphatic polyamide to obtain a mixture having a tan δ peak temperature higher than that of the aliphatic polyamide,
(B) a step, in which (3) plasticizer is added into the mixture obtained in step (A) to obtain a mixture having a tan δ peak temperature lower than the tan δ peak temperature of the mixture obtained in step (A),
(C) a step, in which the mixture obtained in step (B) is used to form a molding product having a high dynamic viscoelasticity (tan δ).

### DETAILED DESCRIPTION OF THE INVENTION

The composition of the present invention contains containing (1) 20-95 wt % of aliphatic polylamide, (2) 1-40 wt % of amorphous polyamide, (3) 0.5-20 wt % of a plasticizer, where the total composition represents 100 wt %.

The polyamide resin composition of the present invention can realize a high dynamic viscoelasticity (tan δ) over a wide temperature range and can provide molding products with excellent dampening property. It is known that the maximum dampening performance will be displayed around the tan δ peak temperature (see for example, Rao, M. D., “Recent Applications of Viscoelastic Damping for Noise Control in Automobiles and Commercial Airplanes”, Journal of Sound and Vibration, Vol 262, (3), 2003, pp 457-474; also Ross, D., Ungar, E. E. and Kerwin, E. M., in Structural Dampening, J. E. Ruzicka ed., ASME, New York, 1959, Sec 3; and Kerwin, E. M., Ungar, J. R., and Rice, E., Sound and vibration damping with polymers; Proceedings of the Symposium, 197^{th} National Meeting of the American Chemical Society, Dallas, Tex., 1989, Proceedings 1990, pp 317-345). The composition of the present invention demonstrates an increased tan δ used as the scale for dampening property. In particular, the composition of the present invention has a relatively low tan δ peak temperature (about 30-100° C.) and can increase tan δ to a high level than in conventional technology. The composition of the present invention can provide molding products with high dampening capability in an average and even in a relatively low temperature range (for example, 50-80° C.) for example for automobile engine compartments. Also, the composition of the present can maintain or improve rigidity and other mechanical characteristics.

Consequently, the polyamide resin composition of the present invention has a tan δ peak temperature in the range of 30-100° C., preferably, in the range of 50-90° C.

In the following, each component in the composition of the present invention will be described.

### Aliphatic Polyamide

There is no particular limitation on the aliphatic polyamide, which can be polyamide 46, polyamide 66, polyamide 610, polyamide 612, polyamide 6, polyamide 11, polyamide 1010, polyamide 1012, polyamide 12, copolymer of PA66 and polyamide 6, copolymer of PA66 and polyamide 610, copolymer of PA66 and polyamide 612, etc. These polyamides can be used either alone or as a mixture of several types. It is preferred to use PA6 in the present invention.

### Amorphous Polyamide

For the amorphous polyamide of the invention the crystal melting heat quantity measured by a differential scanning calorimeter (DSC) is less than 1 cal/g. An example of amorphous polyamide has repeated units comprised of a part derived from an aromatic carboxylic acid and a part derived from aliphatic diamine.

Although there is no special limitation on the aforementioned aromatic carboxylic acid, terephthalic acid and its derivatives and isophthalic acid and its derivatives are preferred. In addition to the aforementioned aromatic carboxylic acid, it is also possible to use succinic acid, adipic acid, suberic acid, sebacic acid, dodecanoic diacid, or other aliphatic carboxylic acids as long as the purpose of the invention is not adversely affected.

Examples of the aforementioned aliphatic diamine include hexamethylene diamine, tetramethylene diamine, 2,5-dimethylhexamethylene diamine, etc.

In the present invention, as described above, an aromatic polyamide derived from aliphatic diamine terephthalic acid and its derivatives or isophthalic acid and its derivatives or other monomers can be used. An example is 6T/6I. In this case, “T” represents a polymer derived from terephthalic acid and its derivative, while “I” represents a polymer derived from isophthalic acid and its derivatives.

The aforementioned amorphous polyamide, for example, can be manufactured as follows. That is, the amorphous polyamide can be manufactured by a polycondensation reaction from the salt of the aforementioned aromatic carboxylic acid and aliphatic diamine. Polymerization is carried out using the conventional melt polymerization method, solid-state polymerization method, solution polymerization method, interfacial polymerization method, etc.

Although the aforementioned amorphous polyamide can be manufactured as described above, it is also possible to use commercially available products, such as Amodel A-1000 (product of Amoco Polymer Corporation) and Zytel® HTN (product of E.I. DuPont de Nemours & Co., Wilmington, Del.).

The content of the aliphatic polyamide component (1) in the polyamide resin composition of the present invention is in the range of 20-95 wt %, preferably, in the range of 30-90 wt % based on the weight of the composition. The content of amorphous polyamide component (2) is in the range of 1-40 wt %, preferably, in the range of 2-20 wt % based on the weight of the composition.

### Plasticizer

There is no particular limitation on the plasticizer used in the present invention as long as it is compatible with aliphatic polyamide component (1) and/or amorphous polyamide component (2). Examples include without limitation water, alcohol, caprolactam, oligomeric amides, sulfone amide type compounds, benzoate type compound, and metal halides. The plasticizer can be pre blended or compounded into one or both of the aforementioned polyamide (such as aliphatic polyamide) or it can be added into the composition of the present invention in other ways. In the present invention, the tan δ peak temperature of the mixture becomes higher than that of the aliphatic polyamide when the amorphous polyamide is mixed with the aliphatic polyamide. However, it returns to the low value when the plasticizer is added. In the present invention, when the plasticizer is added as described above, the tan δ peak temperature of the entire composition (mixture) can be lowered, and the dynamic viscoelasticity (tan δ) of the molding product formed from the composition of the present invention can be increased. The rigidity and other mechanical characteristics of the molding product formed using the composition of the present invention can also be improved.

In the present invention, the content of the plasticizer is in the range of 0.5-20 wt % based on the total formulation.

### Inorganic Filler

The polyamide resin composition of the present invention may also contain filler. Examples of filler include glass fiber, carbon fiber, mica, talc, kaolin, wollastonite, calcium carbonate, and potassium titanate. These fillers can be used either alone or as a mixture of several types. In a preferred embodiment, glass fiber is used since it can improve the rigidity of the resin composition. Also, mica or talc are also preferred fillers.

In the present invention, the content of the inorganic filler is in the range of 0-60 wt %.

If necessary, other additives besides the aforementioned inorganic filler can also be added into the polyamide resin composition of the present invention. Examples of the aforementioned additives include thermal stabilizers, UV absorbents, antioxidants, lubricants, nuclear agents, antistatic agents, demolding agents, dye type coloring agents, pigment type coloring agents, flame retardants, plasticizers, and other resins.

The content of these additives are variable depending on the purpose of the additives. For example, it is preferred to be in the range of 0-10 wt % based on the total weight of the composition.

The composition of the present invention is the form of a mixture homogeneously dispersed in a polymer matrix such that all of the nonpolymerized components are integrated in the entire mixture. The mixture can be obtained by mixing the various components using any melt mixing method. Examples of the melt mixing method include the method in which the various components are homogeneously mixed using a monoaxial or biaxial screw extruder, blender, kneader, Banbury mixer, or other melt mixer (method that melts and mixes the various components of the composition of the present invention at the same time), or the method, in which some of the aforementioned materials are added sequentially or in a special combination by a melt mixer, followed by adding the rest of the materials and performing melt mixing until a homogenous mixture is obtained (the method using multiple stages). In the present invention, it is preferred to perform mixing in a special procedure as in the molding product manufacturing method to be described later. The mixing operation can be carried out continuously or using the batch method. Also, when the composition is prepared in multiple stages, it is also possible to temporarily cool, off and solidify the mixed components between the stages.

The present invention is also directed to a method for manufacturing a molding product using the aforementioned polyamide resin composition.

The first embodiment of the manufacturing method disclosed in the present invention includes (a) a step of mixing and melt blending (1) aliphatic polyamide, (2) amorphous polyamide, and (3) plasticizer and (b) a step of molding the molding product using the composition obtained in step (1).

In the manufacturing method of the present invention, first, the composition of the present invention is mixed by following any of the procedures explained above for the composition manufacturing method. Then, the obtained composition is molded using an injection molding method, blow molding method, sheet molding method, vacuum molding method, or other molding method. The molding conditions can be selected appropriately corresponding to each means. The conventional conditions can be used.

The polyamide resin composition of the present invention has a relatively low tan δ peak temperature (for example, about 30-100° C.). The molding product obtained using the manufacturing method of the present invention has higher tan δ than that in the conventional technology.

The second embodiment of the manufacturing method disclosed in the present invention includes (A) a step, in which (2) amorphous polyamide is added into (1) aliphatic polyamide to obtain a mixture having a tan δ peak temperature higher than that of the aliphatic polyamide, (B) a step, in which (3) plasticizer is added into the mixture obtained in step (A) to obtain a mixture having a tan δ peak temperature lower than the tan δ peak temperature of the mixture obtained in step (A), (C) a step, in which the mixture obtained in step (B) is used to form a molding product having a high dynamic viscoelasticity (tan δ).

In the second embodiment of the manufacturing method, in step (A), the tan δ peak temperature of the mixture can be increased higher than that of the aliphatic polyamide by adding the amorphous polyamide into the aliphatic polyamide. The increased tan δ peak temperature can be returned to the low value again by adding the plasticizer in step (B). When the plasticizer is added, the dynamic visoelasticity (tan δ) of the molding product obtained from the composition (mixture) can also be increased. The rigidity and other mechanical characteristics of the molding product obtained from the composition (mixture) of the present invention can also be improved.

The dynamic visoelasticity (tan δ) is expressed by the following equation.

tan δ=E″/E′

where, E″ represents the loss visoelasticity, E′ represents storage viscoelasticity.

In the second embodiment of the manufacturing method of the present invention, first, amorphous polyamide (2) is mixed with aliphatic polyamide (1). Then, the plasticizer is added into the obtained mixture and mixed. The composition of the present invention is obtained in this way. The obtained composition is molded using the injection molding method, blow molding method, sheet molding method, vacuum molding method, or other molding method to obtain the molding product. The molding conditions can be selected appropriately corresponding to each means. The conventional conditions can be used.

The molding product obtained using the method of the present invention can be used for various types of structural materials, various types of housing materials, automobile parts, household electrical products, electronic machine parts, construction materials, etc.

### EXAMPLES

In the following, the present invention will be explained in more detail with reference to application examples and comparative examples. The present invention, however, is not limited to the examples.

### Preparation of the Composition

Various components were mixed by a biaxial kneader in the composition shown in Table 1. The obtained mixture was pelletized. The various components were mixed at the same time, although they equally well could be mixed in the order of aliphatic polyamide, amorphous polyamide, and plasticizer.

### Production of Test Sample

The pellets obtained as described above were subjected to injection molding performed using an injection molding machine to obtain a test sample.

Measurement of Tan δ

The test sample (sample size: 55×10×4 mm) obtained as described above was measured under the conditions of measurement temperature: 0-150° C. and frequency: 2 Hz using 983 Dynamic Mechanical Analyzer produced by DuPont Instruments Corporation.

### Measurement of Flex [Flexural] Modulus

The test sample obtained using the aforementioned method was measured according to ISO 178.

The following materials were used as the components for the composition of the application examples and comparative examples.

Aliphatic polyamide: Zytel® FE7330J produced by Dupont, Zytel® 21A NC010 (containing 7% of caprolactam (plasticizer)) produced by Dupont

Amorphous polyamide (aromatic amorphous polyamide): Zytel® HTN503 produced by Dupont

Plasticizer: Caprolactam (contained in an amount of 7% in aliphatic polyamide (Zytel 21A NC010; produced by Dupont))

Inorganic filler: Glass fiber (CS FT756D; product of Asahi Glass Co., Ltd.)

TABLE 1

| | Comparative | Comparative | Comparative | Application |
|---|---|---|---|---|
| | Example 1 | Example 2 | Example 3 | Example 1 |
| Composition | (wt %) | (wt %) | (wt %) | (wt %) |
| Aliphatic | 70.0 | 56.2 | | — |
| polyamide | | | | |
| (Zytel FE7330) | | | | |
| Plasticizer- | — | — | 70.0 | 56.2 |
| containing | | | | |
| aliphatic | | | | |
| polyamide | | | | |
| (Zytel | | | | |
| 21A NC010a) | | | | |
| Amorphous | — | 13.8 | | 13.8 |
| polyamide | | | | |
| (Zytel | | | | |
| HTN503) | | | | |
| Inorganic filler | 30.0 | 30.0 | 30.0 | 30.0 |
| (CS FT756D) | | | | |

### Results

The characteristics of the composition of the present invention are shown in Table 2.

TABLE 2

| | | Com- | Com- | Com- | Appli- |
|---|---|---|---|---|---|
| | | parative | parative | parative | cation |
| | | Example 1 | Example 2 | Example 3 | Example 1 |
| Flex [Flexural] | MPa | 8670 | 8790 | 7850 | 9090 |
| Modulus | | | | | |
| Tanδ peak | | 0.069 | 0.125 | 0.077 | 0.141 |
| value | | | | | |
| Tanδ peak | ° C. | 79 | 91 | 63 | 83 |
| temperature | | | | | |
| Tanδ at 50° C. | | 0.026 | 0.019 | 0.064 | 0.030 |
| (1) | | | | | |
| Tanδ at 60° C. | | 0.041 | 0.035 | 0.076 | 0.057 |
| (2) | | | | | |
| Tanδ at 70° C. | | 0.062 | 0.061 | 0.074 | 0.106 |
| (3) | | | | | |
| Tanδ at 80° C. | | 0.069 | 0.100 | 0.063 | 0.140 |
| (4) | | | | | |
| (1) + (2) + (3) + | | 0.198 | 0.215 | 0.277 | 0.333 |
| (4) | | | | | |

As can be seen from the results shown in Table 2, the polyamide resin composition of the present invention not only has a higher tan δ peak than the conventional example but also has higher tan δ in average in a wide temperature range of 50-80° C., which means it has an excellent dampening property.

The polyamide resin composition of the present invention also has excellent rigidity compared with Comparative Examples 1, 2, 3.

1. A composition comprising
(i) between 20-95 wt % of an aliphatic polyamide,
(ii) between 1-40 wt % of a polyamide PA6T6I, and
(iii) between 0.5-20 wt % of a plasticizer, where the weight percentages are by weight of total formulation, and in which the aliphatic polyamide is miscible with the polyamide PA6T6I and the plasticizer is selected from the group consisting of caprolactam, oligoamide, sulfone amide and benzoate.

2. A metal-polymer-metal structural laminate comprising a core of polymeric material having adhered to each side thereof a metal skin layer wherein:
(a) said metal skin layer is about 0.1 mm to about 10 mm thick;
(b) said laminate has a ratio of core thickness to skin thickness of between about 1:3 and about 20:1;
(c) said laminate total thickness is between about 0.3 mm and about 10 mm;
(d) said polymeric material comprises
(i) between 20-95 wt % of an aliphatic polyamide,
(ii) between 1-40 wt % of a polyamide PA6T6I,
(iii) between 0.5-20 wt % of a plasticizer, where the weight percentages are by weight of total formulation, and in which the aliphatic polyamide is miscible with the polyamide PA6T6I and the plasticizer is selected from the group consisting of caprolactam, oligoamide, sulfone amide and benzoate.

3. The structural laminate of claim 2 wherein the metal skin layers on each side of the core are different thicknesses.

4. The structural laminate of claim 2 wherein the metal skin layers on each side of the core comprise different metals.

5. The laminate of claim 2 wherein the ratio of core thickness to skin thickness is between 1:2 and 3:1.

6. The laminate of claim 2 wherein the total laminate thickness is between 0.6 mm and 1.5 mm.

7. The laminate of claim 2 wherein the core comprises a solid filler.

8. The structural laminate of claim 2 wherein the metal skin is steel.

9. The structural laminate of claim 2 wherein the metal skin is aluminum.

10. A method for manufacturing a [sound] dampening molding product characterized by having
(a) a step of mixing (1) aliphatic polyamide, (2) amorphous polyamide, and (3) plasticizer,
(b) a step of molding the molding product using the composition obtained in step (a).

11. A method for manufacturing said dampening molding product characterized by having
(A) a step, in which (2) amorphous polyamide is added into (1) aliphatic polyamide to obtain a mixture having a tan δ peak temperature higher than that of the aliphatic polyamide,
(B) a step, in which (3) plasticizer is added into the mixture obtained in step (A) to obtain a mixture having a tan δ peak temperature lower than the tan δ peak temperature of the mixture obtained in step (A),
(C) a step, in which the mixture obtained in step (B) is used to form a molding product having a high dynamic viscoelasticity (tan δ).
